(19) United States
(12) Patent Application Publication
(10) Pub. No.: US 2026/0084170 A1
(43) Pub. Date: Mar. 26, 2026

(54) FLUID PRODUCT DISPENSER COMPRISING AN ACTUATING PART FOR A STORAGE SUBASSEMBLY

(71) Applicant: ALBEA SERVICES, Gennevilliers (FR)

(72) Inventors: Guy PLIQUET, Gennevilliers (FR); Thomas Emmanuel SOURDEAU, Gennevilliers (FR)

(73) Assignee: ALBEA SERVICES, Gennevilliers (FR)

(21) Appl. No.: 18/996,362

(22) PCT Filed: Dec. 22, 2022
(86) PCT No.: PCT/EP2022/087567

§ 371 Date: Nov. 20, 2025

(30) Foreign Application Priority Data
Jul. 21, 2022 (FR) FR2207497

(51) Int. Cl. B05B 11/10

(52) U.S. Cl. CPC B05B 11/1052; B05B 11/1059

(57) ABSTRACT

The A fluid product dispenser includes a reservoir for the fluid product, a dispensing pump that is attached to the dispensing head by an upper portion of the dispensing pump, an actuating part that is attached to the reservoir and can move axially from a rest position to a product dispensing position, and cam ring that is rotatable relative to the actuating part. The actuating part includes first cam means that cooperate with second cam means on the cam ring such that the axial movement is obtained by a conversion of a rotational movement of the actuating part relative to the cam ring. The axial movement allows the dispensing pump to be actuated. The cam ring further includes at least one first locking means that cooperates with at least one second locking means on the dispenser so as to block the rotational movement of the actuating part relative to the cam ring when the actuating part is in the low rest position.

### CROSS-REFERENCE TO RELATED APPLICATIONS

This application is the National Stage of International Application No. PCT/EP2022/087567, filed on Dec. 22, 2022, which claims priority to French Application No. 2207497, filed on Jul. 21, 2022, and the contents of which are incorporated herein by reference.

### TECHNICAL FIELD OF THE INVENTION

The invention relates to a dispenser for a fluid product comprising an actuating part for a storage subassembly.

The fluid product is of the lotion, gel, perfume or cream type, for example, used for cosmetic purposes or pharmaceutical treatments.

### TECHNICAL BACKGROUND

Some fluid product dispensers have a pump configured to suck the fluid product contained in a container of the dispenser for dispensing it. The product may then be extracted from the dispenser for allowing its application.

The pump is often actuated manually by means of a push button, which the user exerts a pressure to trigger the operation of the pump. Each press of the push button dispenses a dose of fluid product that comes out of a dispensing orifice.

The push button may thus be moved between a high position and a low position, with a return force returning it to its high position. Its actuation allows to actuate the pump to cause the circulation of the product of the container of the dispenser towards the dispensing orifice and the dispensing of the product.

However, the dose is predefined and identical and the user may not vary it, except by exerting more or less pressure on the push button. In other words, the dose dispensed is defined by manually adjusting the height of the press button stroke and the pressure exerted by the user.

Moreover, the pression exerted on the push button may in some cases require a considerable effort, particularly if the fluid product is of a thick consistency.

Furthermore, in some mechanisms, to prevent the pump from remaining under stress in the rest position, the mechanism takes into account the tolerances of the various elements and this results in a clearance between the various elements of the dispenser, particularly in the rest position.

Among other things, this clearance may cause blocking points of the dispensing pump.

This clearance may also cause a chatter effect, which is not good for the user.

There is therefore a need for a solution that allows to solve at least some of the disadvantages mentioned while retaining a dispenser that is similar in efficiency to the known dispensers.

### SUMMARY OF THE INVENTION

Thus, according to a first aspect, the invention relates to a fluid product dispenser comprising:
a container for the fluid product,
a dispensing pump attached to the dispensing head by an upper part of the pump,
an actuating part attached to said container and capable of being displaced according to an axial displacement from a rest position towards a product dispensing position, and
a cam ring movable in rotation relative to the actuating part,
   the actuating part comprising first cam means cooperating with second cam means of the cam ring so that the axial displacement is obtained by a transformation of a rotational movement of the actuating part with respect to the cam ring, the axial displacement allowing an actuation of the dispensing pump,
   the cam ring further comprising at least one first locking means cooperating with at least one second locking means of the dispenser so as to block the rotational movement of the actuating part with respect to the cam ring when the actuating part is in the rest position.

The locking means allows to limit the chatter effects, i.e. the floating or unbalanced effect of the various movable parts of the dispenser, particularly when the actuating part is in the rest position. The locking means allow to limit any rotational clearance when the dispensing pump is in the rest position. The sensation for the user is much more pleasant.

In addition, the locking means allow to create a sensitive “click” at the start and end of the stroke. The user therefore knows when he starts to activate the dispensing pump and when the dose has been fully dispensed. The user naturally realizes that the system is in the rest position.

According to various embodiments of the invention, which may be taken together or separately:
the fluid product is a cosmetic product or a pharmaceutical product,
the axial displacement is from a rest position towards a fluid product dispensing position,
the rest position is a low position of the actuating part,
the product dispensing position is a high position of the actuating part,
the actuating part is attached directly to the container,
the actuating part is connected in a sealing manner to the container,
the dispenser comprises a rotary shrink ring connected in rotation to the actuating part,
the at least one second locking means being located on the rotary shrink ring,
the dispensing pump may be actuated from a lower part of the pump,
the dispensing pump comprises a pump body and a rod axially movable relative to each other, the rod being connected to the pump body at a lower end and attached to the dispensing head at an upper end of the dispensing pump,
the rod has a full or partial stroke,
the pump body is wedged in abutment,
the rod is wedged in abutment, the rod is held in place by friction,
the dispensing head comprises a dispensing orifice,
the upper end of the rod is attached to the dispensing head at the level of the dispensing orifice,
the rod is connected to the pump body so that the pump body and the rod are axially movable relative to each other,
the cam ring is mounted on a receptacle of the dispenser, the dispensing pump is wedged upwards before or when the dispenser is used for the first time,
the first cam means are cam followers configured to follow a trajectory of the second cam means of the cam ring,
the cam followers are radial protrusions configured to follow the trajectory of the second cam means of the cam ring,
the first cam means are radial protrusions configured to follow a trajectory of the dispenser,
the actuating part comprises three first cam means,
the actuating part comprises three first cam means,
the actuating part comprises three cam followers,
the actuating part comprises three radial protrusions,
the cam ring comprises a cam trajectory having at least two recesses and two summits,
the cam trajectory is wave-shaped,
the cam trajectory has between three and eight recesses,
the cam trajectory has between three and eight summits,
the cam trajectory has the same number of recesses and summits,
the cam trajectory has three recesses and three summits,
the container is a flexible pouch,
the fluid product dispenser comprising a storage subassembly,
the storage subassembly comprises a container for the fluid product, the actuating part and the dispensing pump,
the receptacle is configured to receive the storage subassembly,
the at least one first locking means is an elastic protuberance protruding from an upper surface of the cam ring,
the at least one first locking means is an elastic protuberance protruding radially from a surface of the cam ring,
the at least one first locking means has an axial elasticity,
the protuberance comprises access ramps on either side,
the protuberance has a chamfer at least on both sides,
the at least one second locking means is a notch located on a lower surface of the rotary shrink ring,
the cam ring comprises a single locking means,
the rotary shrink ring comprises three second locking means,
the at least one first locking means and the at least one second locking means are made of different materials,
the material of the at least one first locking means is more resistant to the ageing than the material of the at least one second locking means,
the ageing is an ageing under stress.

According to a second aspect, the invention relates to an actuating part configured to be mounted in a dispenser of a fluid product and to actuate a dispensing pump, the actuating part comprising:
at least one connecting means for attachment to a container of the dispenser,
a cavity configured to receive the dispensing pump,
the first cam means,
   the actuating part being capable of being displaced when it is mounted in the dispenser according to an axial displacement, the axial displacement being obtained by transforming a rotational movement of the actuating part by the first cam means, the axial displacement allowing to actuate the dispensing pump for dispensing the fluid product.

Unlike conventional systems where the dispensing pump is actuated by pressing a push button, here the dispensing pump is actuated by a simple rotational movement of at least one part relative to another. This allows to give more force to the pump, which is particularly useful for thick fluid products.

In addition, each rotation movement allows to dispense a precise dose of fluid product. This makes it easier for the user to feel when the entire dose of fluid product has been dispensed.

According to a third aspect, the invention relates to a fluid product dispenser comprising:
a dispensing head for dispensing the fluid product,
a container for the fluid product,
a dispensing pump attached to the dispensing head by an upper part of the pump,
an actuating part attached to said container and capable of being displaced according to an axial displacement, and
a cam ring movable in rotation relative to the actuating part,
   the actuating part comprising first cam means cooperating with second cam means of the cam ring so that the axial displacement is obtained by a transformation of a rotational movement of the actuating part with respect to the cam ring, the axial displacement allowing an actuation of the dispensing pump.

The special mounting of the dispensing pump from above allows to ensure that the dispensing pump may move vertically without blocking point.

This means that if any clearance occurs during rotational and axial movements, there is an angular offset between the cam followers and the cam trajectory and a spacing of the cam followers relative to the cam trajectory in the recesses when the dispensing rod has reached its abutment.

This means that there is no blocking point in either the high position (i.e. the position of maximum dispensing rod penetration) or the low position (spacing of the cam followers and the cam trajectory when the dispensing rod is in its position of minimum penetration).

### BRIEF DESCRIPTION OF THE FIGURES

The invention will be better understood, and other characteristics and advantages thereof will become apparent in the course of the detailed description which follows, of at least two examples of embodiment of the invention given by way of purely illustrative and non-limiting examples, with reference to the annexed schematic drawings wherein:
FIG. 1 is an exploded perspective view of a first example of a fluid product dispenser according to the invention;
FIG. 2 is a longitudinal sectional view of the dispenser in FIG. 1 in a rest position;
FIG. 3 is a longitudinal sectional view of the dispenser in FIG. 1 in a dispensing position;
FIG. 4 is an exploded perspective view of a dispensing head of the dispenser in FIG. 1;
FIG. 5 is an exploded perspective view of a storage subassembly of the dispenser in FIG. 1;
FIG. 6 is a perspective view of a cam ring of the dispenser in FIG. 1;
FIG. 7 is a perspective view of a rotary shrink ring of the dispenser in FIG. 1;
FIG. 8 is a detail view of a cam system of the dispenser of FIG. 1;

FIG. 9 is a detailed view of a locking system for the dispenser in FIG. 1;
FIG. 10 is a longitudinal sectional view of a second example of a dispenser according to the invention in a dispensing position.

### DETAILED DESCRIPTION OF THE INVENTION

By convention, the “axial” direction in the figures corresponds to that of the main axis X of a dispenser 10 for a fluid product configured to receive a dispensing head 12, and the “radial” direction is orthogonal to the axial direction.

In the following detailed description of the figures, the terms “upper” and “lower” or “high” and “low” will be used without limitation in reference to the axial direction. The upper part of the dispenser 10 corresponds, in this case, to the part where the dispensing head 12 is positioned.

Similarly, the terms “outer or external” and “inner or internal” are used with reference to the radial direction, an outer element being radially further from the axis X than an inner element.

FIGS. 1 to 3 illustrate a first example of a fluid product dispenser 10 according to the invention.

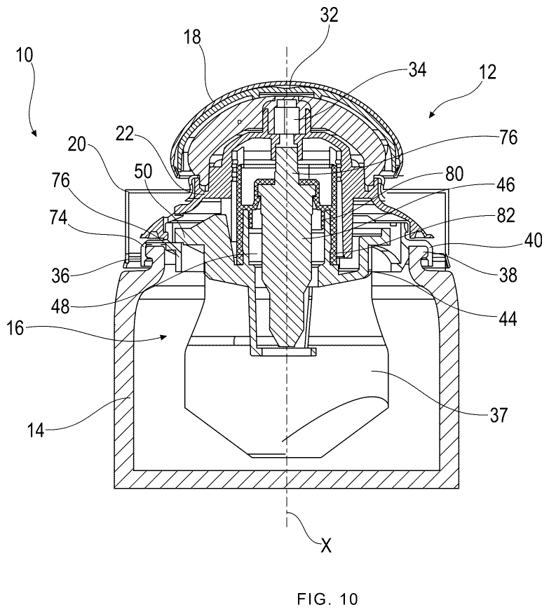

FIG. 10 shows a second example of a fluid product dispenser 10 according to the invention.

The dispenser 10 comprises an upper part in the form of a dispensing head 12 shown in FIG. 4 and a lower part in the form of a receptacle 14.

Advantageously, the upper part is movable in rotation relative to the lower part. Thus, a rotation of the upper part relative to the lower part, i.e. a rotation of the dispensing head 12 relative to the receptacle 14, allows an outlet of the fluid product contained in a storage subassembly 16 located in the receptacle 14.

The dispensing head 12, shown in FIG. 4, comprises a dispensing dome 18, an attachment ring 20 and a rotary shrink ring 22 assembled together so as to be rotationally and axially connected. In other words, the rotation of the dispensing dome 18 and/or the attachment ring 20 relative to the receptacle 14 causes the rotation of the rotary shrink ring 22.

The attachment ring 20 is configured to surround the rotary shrink ring 22 and is surmounted by the dispensing dome 18.

In the examples shown, the dispensing dome 18 comprises axial tongues 24 each with a through hole 25. The axial tongues 24 cooperate with cut-outs 26 in the attachment ring 20 located at the level of an upper opening and with connecting means on the rotary shrink ring 22.

The connecting means of the rotary shrink ring 22 are slits 28 wherein the axial tongues 24 of the dispensing dome 18 are housed and protrusions 30 which are inserted in the holes 25 of the axial tongues 24 of the dispensing dome 18.

The dispensing dome 18 comprises a dispensing orifice 32 through which the fluid product exits and into which a dispensing orifice 34 of the rotary shrink ring 22 opens.

In the examples shown, the lower part is composed of the receptacle 14 and a cam ring 36.

The receptacle 14 is configured to receive the storage subassembly 16, in particular a container 37 of the storage subassembly 16 which is housed inside.

The receptacle 14 is also designed to receive the cam ring 36 which is attached to it, particularly on its upper part. To achieve this, the receptacle 14 comprises an upper rim forming a shoulder 38 which is housed in an annular groove 40 formed by an annular bead 42 on the cam ring 36. The cam ring 36 is thus held axially on the receptacle 14.

In the examples shown and as may be seen in FIG. 5, the storage subassembly 16 comprises the fluid product container 37, an actuating part 44 and a dispensing pump 46.

According to the invention, the actuating part 44 is configured to be mounted in the fluid product dispenser 10 and to actuate the dispensing pump 46.

The actuating part 44 comprises:
at least one connecting means for attachment to the container 37 of the dispenser 10,
a cavity 48 configured to receive the dispensing pump 46,
first cam means 50.

In the examples shown, the actuating part 44 is a circular part comprising a circular peripheral annulus 52 and a cylindrical central housing of circular cross-section forming the cavity 48 configured to receive the dispensing pump 46. The cavity 48 is connected to the peripheral annulus 52 by a transverse wall 54 extending from the peripheral annulus 52 towards a longitudinal wall 56 of the cavity 48.

Arms 58, of which there are three here, are used, among other things, to reinforce the circular structure of the peripheral annulus 52. The arms 58 extend from the cavity 48 towards the peripheral annulus.

The central housing is extended vertically downwards by a chassis supporting a lower part of the pump 52.

The actuating part 44 also comprises means for attaching to the container 37. Advantageously, the actuating part 44 is attached directly to the container 37. Preferably, the actuating part 44 is connected in a sealed manner to the container 37.

### In the Examples Shown Here, the Actuating Part 44 Is Welded to the Container

37.

Preferably, the container 37 is a flexible pouch. Preferably, the container 37 is a multilayer composed of at least one layer of plastic and at least one layer of aluminum.

Flexible means that it may be deformed without breaking or deteriorating. In other words, the flexible pouch may be deformed without breaking or being damaged.

Advantageously, the flexible pouch allows the use of an airless system, with the flexible pouch retracting as the fluid product is consumed.

The actuating part 44 is also capable of being displaced when it is mounted in the dispenser 10 according to an axial displacement, the axial displacement being obtained by transforming a rotational movement of the actuating part 44 by the first cam means 50. The axial displacement allows the fluid product dispensing pump 46 to be activated.

The axial displacement takes place from a rest position towards a fluid product dispensing position.

In the examples shown, the rest position is a low position of the actuating part 44 visible in FIG. 2 and the product dispensing position is a high position of the actuating part 44 visible in FIG. 3.

Advantageously, the rotary shrink ring 22 and the actuating part 44 are connected in rotation, with the rotation of the rotary shrink ring 22 causing the rotation of the actuating part 44.

In the examples shown here, the rotary shrink ring 22 comprises an internal skirt 60 provided with slots 62, here three in number, into which the three arms 58 of the actuating part 44 are inserted so that the rotary shrink ring 22 and the actuating part 44 are connected in rotation.

As the rotary shrink ring 22 is connected in rotation with the dispensing dome 18 and/or the attachment ring 20, the rotation of the dispensing dome 18 and/or the attachment ring 20 relative to the receptacle 14 causes the actuating part 44 to rotate. In other words, the rotation of the upper part of the dispenser 10 relative to the lower part of the dispenser 10 causes the actuating part 44 to rotate.

Advantageously, the rotation may be made by turning towards the left or towards the right.

Advantageously, the first cam means 50 are cam followers configured to follow a trajectory 64 of the dispenser 10.

Preferably, the trajectory of the dispenser 10 is the trajectory 64 formed by second cam means 66 of the cam ring 36.

Preferably, the first cam means 50 are radial protrusions configured to follow the trajectory 64 of the dispenser 10.

In the examples shown here, the first cam means 50 are three radial protrusions located on an external surface of the peripheral annulus 52. The protrusions extend from the external surface outwards. They have a semi-circular cross-section with the flat side facing upwards and the arc of the circle facing downwards. The circular arc is in contact with the cam trajectory 64.

Advantageously, the cam trajectory 64 has summits 68 and recesses 70 so as to allow an axial displacement of the actuating part 44. Preferably, the cam trajectory 64 has at least two summits 68 and two recesses 70.

In the examples shown, the cam ring 36 comprises a wave-shaped cam trajectory 64 with three summits 68 and three recesses 70, as may be seen in FIG. 6.

In the examples shown here, particularly in FIG. 6, the cam ring 36 is a circular ring comprising an internal wall 72 and an external wall 74.

The internal surface of the internal wall 72 has the cam trajectory 64.

The internal surface of the external wall 74 comprises the annular bead 42 forming the annular groove 40 wherein the shoulder 38 of the upper rim of the receptacle 14 is housed.

In other words, the annular groove 40 is formed between the internal wall 72 and the external wall 74 and the upper rim of the receptacle 14 is housed in the space formed between the two external 74 and internal 72 walls.

Advantageously, the cam ring 36 is mounted axially stationary on the receptacle 14 and movable in rotation relative to the actuating part 44.

The cam ring 36 thus comprises second cam means 66 cooperating with the first cam means 50 of the actuating part 44 of the storage subassembly 16, so as to as to obtain the transformation of the rotational movement of the actuating part 44 with respect to the cam ring 36 into axial displacement of the actuating part 44 from the low rest position towards the high dispensing position, the axial displacement allowing the actuation of the dispensing pump 46 of the fluid product.

The dispensing pump 46 is attached to the dispensing head 12 by an upper part of the pump which is connected at the level of a dispensing orifice 32, 34 for the fluid product, preferably located at the top of the dispensing head 12.

Advantageously, the dispensing pump 46 comprises a pump body and a dispensing rod 76 which are axially movable relative to each other.

Preferably, the dispensing pump 46 is attached by a dispensing rod 76.

In the examples shown, the dispensing rod 76 is connected to the pump body by a lower end and attached to the dispensing head 12 by an upper end of the dispensing pump 76.

In the examples shown here, the dispensing pump 46 is said to be perched. In other words, the dispensing pump 46 is attached by the dispensing rod 76 at the level of the dispensing orifice 34 of the rotary shrink ring 22.

In the first example, the dispensing rod 76 is in high abutment against a shoulder 78 of the dispensing orifice 34 of the rotary shrink ring 22, as may be seen in FIGS. 2 and 3. The dispensing pump 46 is thus wedged upwards. In the second example shown in FIG. 10, the dispensing pump 46 is held by friction of the dispensing rod 76 at the level of the dispensing orifice 34 of the rotary shrink ring 22.

Advantageously, the dispensing pump 46 is wedged upwards before or when the dispenser 10 is used for the first time. In other words, before (i.e. during manufacture) or on first use, the dispensing rod 76 is blocked in a vertical axial abutment. This allows the passage at the high point of the cam path to correspond to a position of maximum depression of the dispensing rod 76 in the dispensing pump 46.

The pump is connected to the dispensing rod 76 so that it may move axially. The axial displacement of the dispensing pump 46 is induced by the actuating part 44.

The rotation of the dispensing dome 18 and/or the attachment ring 20 relative to the receptacle 14 causes the rotation of the rotary shrink ring 22 and of the actuating part 44.

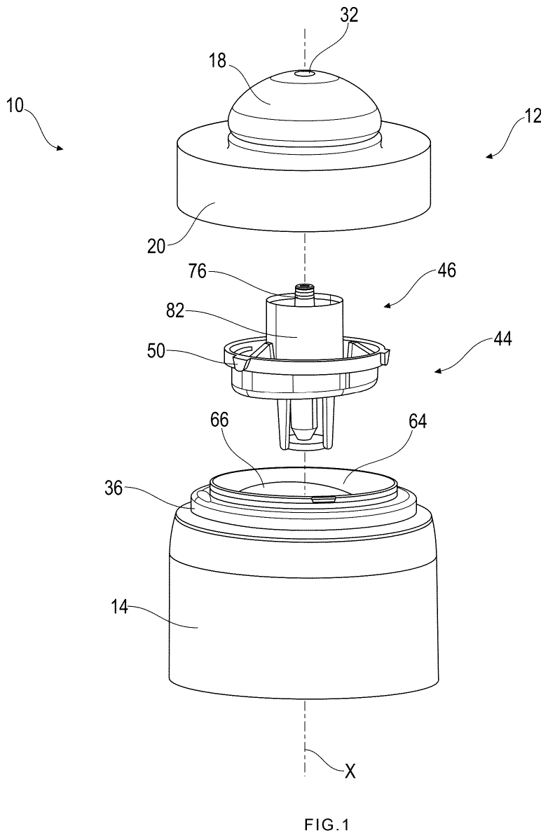

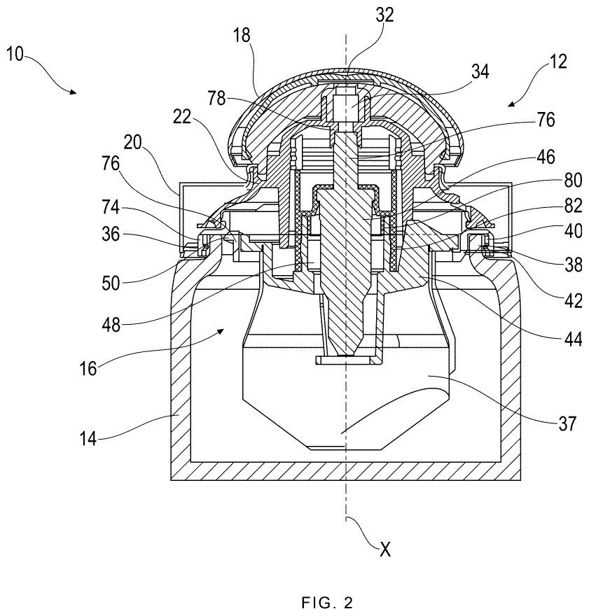

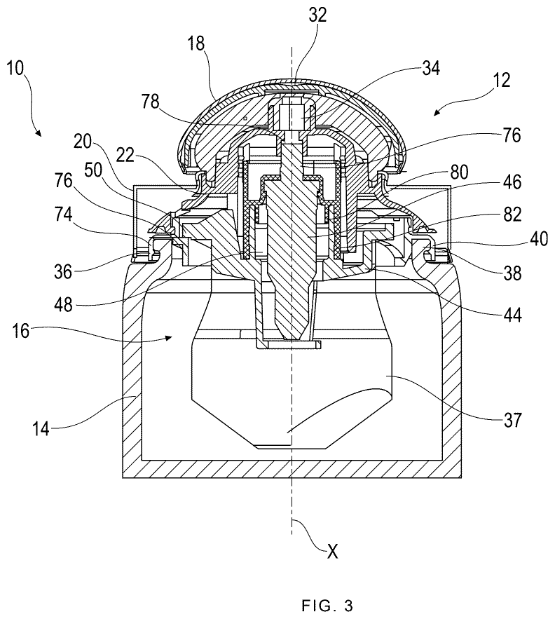

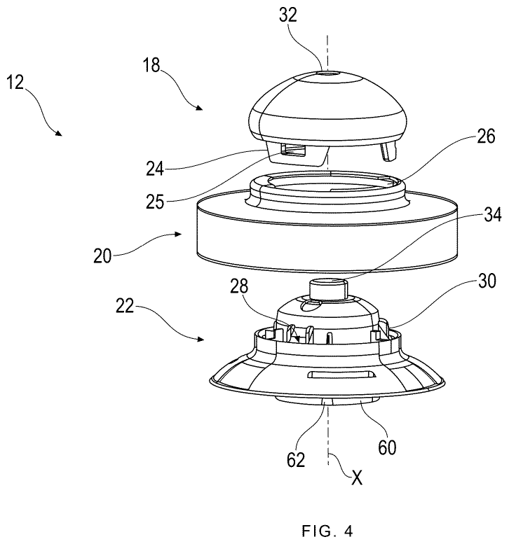

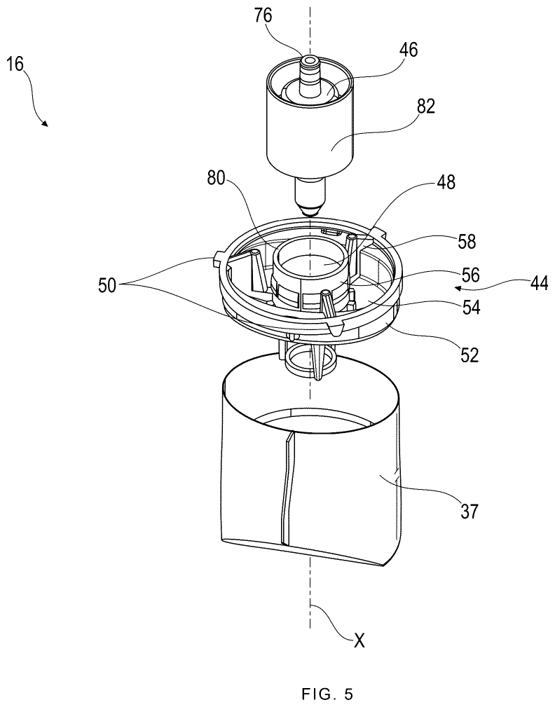

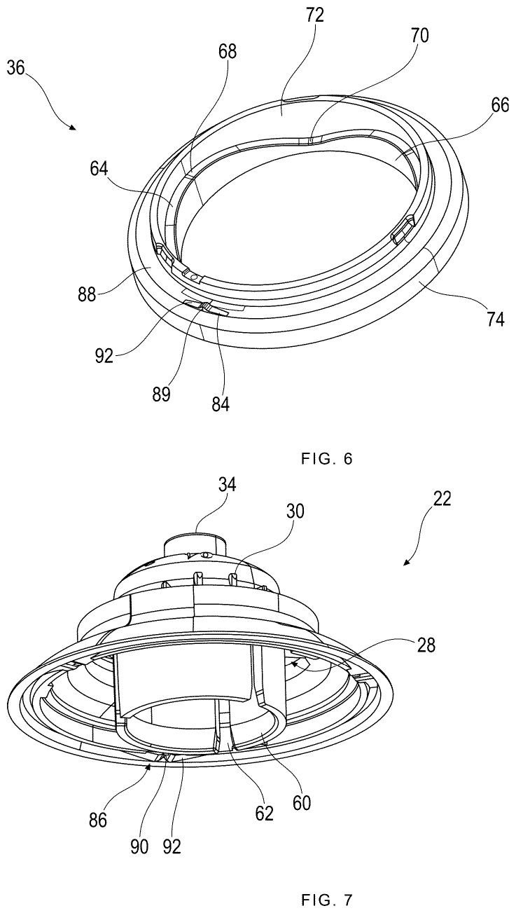

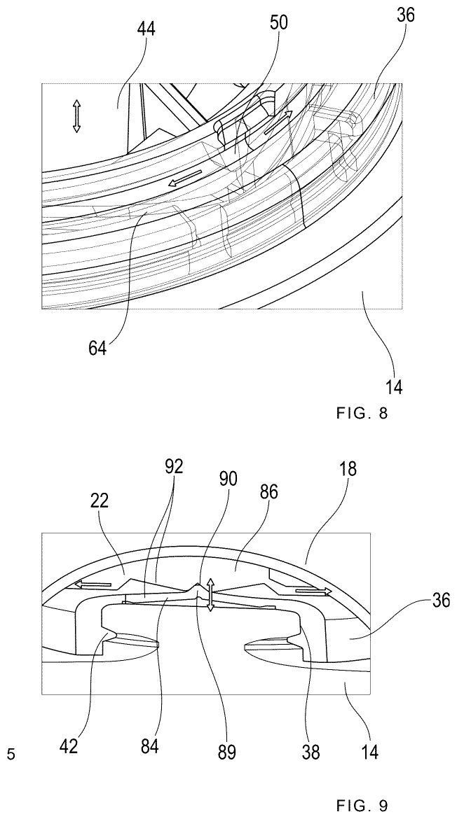

During this rotation, the cam followers (first cam means 50) of the actuating part 44 follow the cam trajectory 64 of the cam ring 36, which has recesses 70 and summits 68, as shown in FIG. 8. This trajectory 64, composed of a series of recesses 70 and summits 68, allows to induce the axial displacement in the actuating part 44.

An upper rim 80 of the cavity 48 of the actuating part 44 designed to receive the dispensing pump 46 rests on a pump support 82 wherein the dispensing pump 46 is stationary housed and then drives the axial displacement of the dispensing pump 46 and its activation.

Each rotation of the upper part of the receptacle 14 allows the activation of the dispensing pump 46 and the distribution of a dose of fluid product.

The number of recesses 70 and summits 68 allows to determine the quantity of dose dispensed.

In the examples shown here, the trajectory 64 comprises three recesses 70 and three summits 68, so that a 120° rotation of the upper part of the receptacle 14 allows a dose to be dispensed.

The cam system allows a transformation of the rotational movement of the dispensing pump 46 into a translational movement and the distribution of the fluid product.

In addition, advantageously, the particular mounting of the dispensing pump 46 from the top makes it possible to ensure a vertical movement of the dispensing pump 46 without blocking point.

Thus, if any clearance occurs during the rotational and axial movements, there is an angular offset between the cam followers and the cam trajectory 64 and a spacing of the cam followers relative to the cam trajectory 64 in the recesses 70 when the dispensing rod 76 has reached its abutment.

There is therefore no blocking point in the high position (i.e. in the position of maximum penetration of the dispensing rod 76) or in the low position (spacing of the cam followers and of the cam trajectory 64 when the dispensing rod 76 is in its position of minimum penetration).

In addition, the cam ring 36 comprises at least one first locking means 84 designed to cooperate with at least one second locking means 86 of the rotary shrink ring 22.

The locking means 84, 86 allow to limit the chatter effects, i.e. a floating, unbalanced effect, of the various movable parts of the dispenser 10, particularly when the actuating part 44 is in the rest position. The locking means 84, 86 allow to limit any rotational clearance when the dispensing pump 46 is in the rest position. The sensation for the user is much more pleasant.

In addition, the locking means 84, 86 allow to create a sensitive “click” at the start and the end of the stroke. The user therefore knows when he starts to activate the dispensing pump 46 and when the dose has been fully dispensed. The user naturally realizes that the system is in the rest position.

Advantageously, the at least one first locking means 84 of the cam ring 36 has axial elasticity. For example, the elasticity is achieved by thinning the thickness of the at least one first locking means 84.

The feeling of passing the notches at the beginning and end of the stroke is obtained by a vertical deformation rather than radial deformation as in conventional systems. The tolerances are reduced.

In the examples shown, the internal wall 72 and the external wall 74 of the cam ring 36 are connected by a transverse shoulder forming an upper surface 88 of the cam ring 36 and on which the first locking means 84 is located.

In the examples shown here, the cam ring 36 comprises a single first locking means 84. This is an elastic protuberance 89 protruding from the upper surface 88 of the transverse shoulder of the cam ring 36. The rotary shrink ring 22 comprises three second locking means 86. These are notches 90 located on a lower surface of the rotary shrink ring 22.

The protuberance 89 and the notches 90 have access ramps 92 on either side so as to facilitate the passage of the protuberance 89 of the cam ring 36 and its placement in one of the notches 90 of the rotary shrink ring 22. The result is a pleasant feeling of passing between the beginning and end of the stroke notch, neither too strong nor too weak.

In another example not shown, the first locking means 84 extends over a portion of the upper surface of the cam ring 36 so as to allow a larger locking area that is easier for the user to detect. It also provides a gradual brake and an adjustable height that may be adjusted to compensate for manufacturing tolerances, for example.

Advantageously, the at least one first locking means 84 and the at least one second locking means 86 are made of different materials, the material of the at least one first locking means 84 being more resistant to ageing than the material of the at least one second locking means 86.

In this case, the ageing is an ageing under stress due to friction between the first and the second locking means.

The at least one first locking means 84 located on the rotary shrink ring 22 are preferably made of polypropylene.

The second locking means 86 located on the cam ring 36 are preferably made of polyoxymethylene (POM), a material which is more resistant to the ageing under stress.

1. A fluid product dispenser comprising:
a dispensing head for dispensing the fluid product,
a container for the fluid product,
a dispensing pump attached to the dispensing head by an upper part of the dispensing pump,
an actuating part attached to said container and capable of being displaced according to an axial displacement from a rest position towards a product dispensing position, and
a cam ring movable in rotation relative to the actuating part,
the actuating part comprising first cam means cooperating with second cam means of the cam ring so that the axial displacement is obtained by a transformation of a rotational movement of the actuating part with respect to the cam ring, the axial displacement allowing an actuation of the dispensing pump,
the cam ring further comprising at least one first locking means cooperating with at least one second locking means of the dispenser so as to block the rotational movement of the actuating part with respect to the cam ring when the actuating part is in a low rest position.

2. The dispenser according to claim 1, comprising a rotary shrink ring connected in rotation with the actuating part, the at least one second locking means being located on the rotary shrink ring.

3. The dispenser according to claim 2, wherein the at least one first locking means is an elastic protuberance protruding from an upper surface of the cam ring.

4. The dispenser according to claim 1, wherein the at least one first locking means is an elastic protuberance protruding radially from a surface of the cam ring.

5. The dispenser according to claim 4, wherein the protuberance comprises access ramps on either side.

6. The dispenser according to claim 2, wherein the at least one second locking means is a notch located on a lower surface of the rotary shrink ring.

7. The dispenser according to claim 1, wherein the at least one first locking means and the at least one second locking means are made of different materials, the material of the at least one first locking means being more resistant to ageing than the material of the at least one second locking means.

8. The dispenser according to claim 1, wherein the cam ring is mounted on a receptacle of the dispenser.

9. The dispenser 9 according to claims claim 1, wherein the first cam means are cam followers configured to follow a trajectory of the second cam means of the cam ring.

10. The dispenser according to claim 9, wherein the cam followers are radial protrusions configured to follow the trajectory of the second cam means of the cam ring.

11. The dispenser according to any claim 1, wherein the cam ring comprises a cam trajectory having at least two recesses and two summits.
